(19) United States
(12) Patent Application Publication
(10) Pub. No.: US 2009/0235221 A1
(43) Pub. Date: Sep. 17, 2009

(54) ROUTING CHANNEL DISPLAYING METHOD AND COMPUTER-ACCESSIBLE STORAGE MEDIUM THEREOF

(75) Inventors: Xiao-Jiao Ding, Shanghai City (CN); Wen-Kang Fan, Taipei City (TW)

Correspondence Address: J C PATENTS, INC., 4 VENTURE, SUITE 250, IRVINE, CA, 92618, US

(73) Assignee: INVENTEC CORPORATION, Taipei City (CN)

(21) Appl. No.: 12/108,816

(22) Filed: Apr. 24, 2008

(30) Foreign Application Priority Data
Mar. 11, 2008 (CN) 200810083789.6

(51) Int. Cl. G06F 17/50

(52) U.S. Cl. 716/13

(57) ABSTRACT

A routing channel displaying method and a computer-accessible storage medium are provided. In the method, a circuit board is divided into m×n blocks which form a matrix with size m×n, and m, n are positive integers. Then, a processing direction is determined by a relative position of a first and a second component of the circuit board. After dividing the blocks into at least one set of processing blocks according to the processing direction, an analysis of the used space rate is sequentially performed on each set of the processing blocks. Finally, all blocks in each set of the processing blocks are labeled according to the result of the analysis of the used space rate so as to display at least one routing channel between the first component and the second component. Thereby, the probability of rerouting is reduced, and the routing efficiency of the circuit board is improved.

### CROSS-REFERENCE TO RELATED APPLICATION

This application claims the priority benefit of P.R.C. patent application serial no. 200810083789.6, filed on Mar. 11, 2008. The entirety of the above-mentioned patent application is hereby incorporated by reference herein and made a part of specification.

### BACKGROUND OF THE INVENTION

1. Field of the Invention

The present invention generally relates to a routing method, in particular, to a routing channel displaying method of a circuit board and a computer-accessible storage medium storing a program for executing the method.

2. Description of Related Art

In the design of a circuit board, routing is undoubtedly the most complicated and variable but critical process. Whether the routing is perfect and whether the signal completeness is ensured may directly affect the performance and reliability of products using the circuit board. Besides, the time required by routing also changes with the speed of the designed operation.

The routing may be affected by various factors, and for different products or circuit designs, the requirements on routing are also varied. Therefore, in a complicated circuit design, even those rather experienced engineers may fail in completing the routing between certain components and have to reroute. For example, with a large increase in the number of the components on a circuit board, the routing density rises accordingly. As a result, when the engineers route a very complicated circuit board, some components may not be easily connected due to the lack of space, and thus more time is required to search for the routing channels.

However, in most circumstances, it is impossible to determine whether the circuit board still has channels for routing, so the engineers have no choice but delete all the finished traces, and reroute the circuit board. It is obvious that this processing manner not only wastes plenty of time but affects the process of the design.

### SUMMARY OF THE INVENTION

Accordingly, the present invention is directed to a routing channel displaying method, so as to automatically display all the possible routing channels on a circuit board, thereby avoiding unnecessary rerouting and improving the routing efficiency.

The present invention is further directed to a computer-accessible storage medium, in which a stored program is executed to display all the routing channels on a circuit board, thus facilitating the routing work for the engineers.

The present invention provides a routing channel displaying method applicable to a circuit board. The method includes: first, dividing the circuit board into m×n blocks which form a matrix with size m×n, in which m, n are positive integers; then, determining a processing direction by a relative position of a first component and a second component of the circuit board; next, dividing the blocks into at least one set of processing blocks according to the processing direction; performing an analysis of used space rate sequentially on each set of the processing blocks; and finally, labelling all blocks in each set of the processing blocks according to a result of the analysis of the used space rate so as to display at least one routing channel between the first component and the second component.

In an embodiment of the present invention, the step of determining the processing direction by the relative position of the first component and the second component of the circuit board further includes: if a horizontal distance between the first component and the second component is larger than or equal to a perpendicular distance, determining a horizontal direction as the processing direction; and if the horizontal distance is smaller than the perpendicular distance, determining a perpendicular direction as the processing direction.

In an embodiment of the present invention, the step of dividing the blocks into at least one set of the processing blocks according to the processing direction further includes: if the processing direction is the horizontal direction, dividing the blocks in the same column of the circuit board into the same set of the processing blocks; and if the processing direction is the perpendicular direction, dividing the blocks in the same row of the circuit board into the same set of the processing blocks.

In an embodiment of the present invention, the step of performing the analysis of the used space rate sequentially on each set of the processing blocks further includes: if the processing direction is the horizontal direction, performing the analysis of the used space rate sequentially on each set of the processing blocks from the set of the processing blocks nearest to one of the first component and the second component along the horizontal direction to the other one of the first component and the second component; and if the processing direction is the perpendicular direction, performing the analysis of the used space rate sequentially on each set of the processing blocks from the set of the processing blocks nearest to one of the first component and the second component along the perpendicular direction to the other one of the first component and the second component.

In an embodiment of the present invention, the step of performing the analysis of the used space rate sequentially on each set of the processing blocks further includes: calculating a used space rate of each of the blocks in the set of the processing blocks. The step of calculating the used space rate of each of the blocks further includes taking a ratio of a used area and a block area of each block as the used space rate. The used area may be a via area, a trace area, or a pin area.

In an embodiment of the present invention, after the step of calculating the used space rate of each of the blocks, the method further includes comparing each used space rate with a routing space threshold. The method further includes calculating a difference between a block area and a minimum area for routing, and taking a ratio of the difference and the block area as the routing space threshold.

In an embodiment of the present invention, the step of labelling all blocks in each set of the processing blocks according to the result of the analysis of the used space rate so as to display at least one routing channel further includes labelling the blocks with the used space rate smaller than or equal to the routing space threshold in each set of the processing blocks.

In an embodiment of the present invention, after the step of comparing each used space rate with the routing space threshold, the method further includes sorting all the used space rates smaller than or equal to the routing space threshold in an ascending sequence in each set of the processing blocks. Besides, the step of displaying at least one routing channel according to the result of the analysis of the used space rate further includes labelling the corresponding blocks by different colors according to the sort result of the used space rates in each set of the processing blocks. In which, the step of labelling the corresponding blocks by different colors further comprises labelling each corresponding block by a color of descending brightness according to the sort result.

The present invention further provides a computer-accessible storage medium for storing a program to implement the routing channel displaying method.

In view of the above, the present invention first divides a circuit board into several blocks, then analyzes whether each of the blocks has space for routing according to a particular sequence, and labels all the blocks with routing space so as to display all the possible routing channels between two components. Therefore, under the precondition that it is likely to successfully route a circuit board, all the possible routing channels will be displayed for the engineers, thereby improving the routing efficiency of the circuit board.

In order to make the aforementioned and other objectives, features, and advantages of the present invention comprehensible, embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a flow chart of a routing channel displaying method according to an embodiment of the present invention.

FIG. 2 is a schematic view of a circuit board according to an embodiment of the present invention.

FIG. 3 is a schematic view of a circuit board according to another embodiment of the present invention.

FIG. 4 is a flow chart of performing an analysis of the used space rate on each set of the processing blocks and displaying at least one routing channel based on the analysis result according to an embodiment of the present invention.

FIG. 5 is a flow chart of performing an analysis of the used space rate on each set of the processing blocks and displaying at least one routing channel based on the analysis result according to another embodiment of the present invention.

### DESCRIPTION OF THE EMBODIMENTS

Reference will now be made in detail to the present embodiments of the invention, examples of which are illustrated in the accompanying drawings. Wherever possible, the same reference numbers are used in the drawings and the description to refer to the same or like parts.

Since the circuit board design becomes increasingly complicated, the time for routing has become one of the main factors that affect the design process of the products. If a mechanism capable of exactly displaying all the possible channels for routing on a circuit board is provided and further combined with practical experience of the engineers, the routing efficiency of the circuit board can surely be enhanced. Based on the above point of view, the present invention provides a routing channel displaying method and a computer-accessible storage medium thereof. In order to make the present invention more comprehensible, embodiments are given below as applications of the present invention.

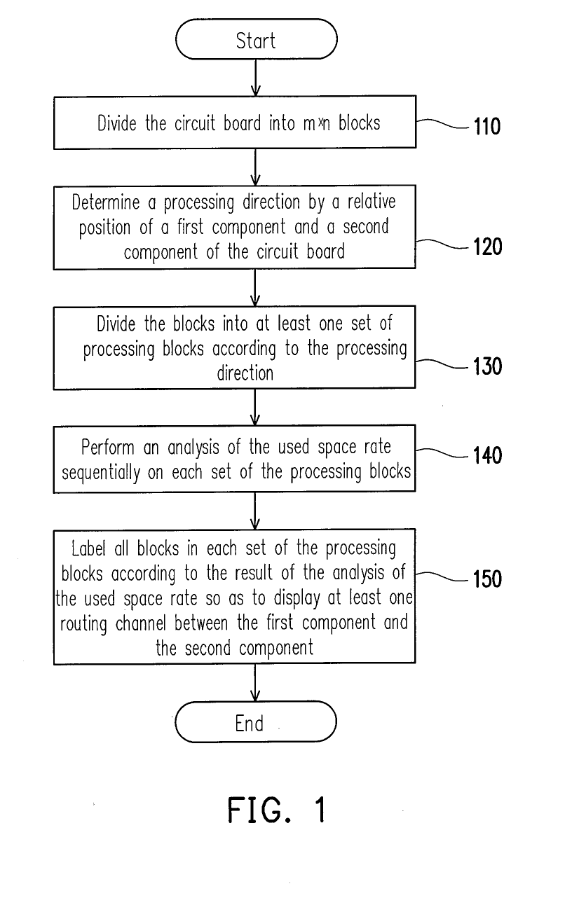

FIG. 1 is a flow chart of a routing channel displaying method according to an embodiment of the present invention. This embodiment gives detailed steps of the method for displaying all the possible routing channels between a first component and a second component on a circuit board. Referring to FIG. 1, first, in Step 110, the circuit board is divided into m×n blocks which form a matrix with size m×n (m, n are positive integers).

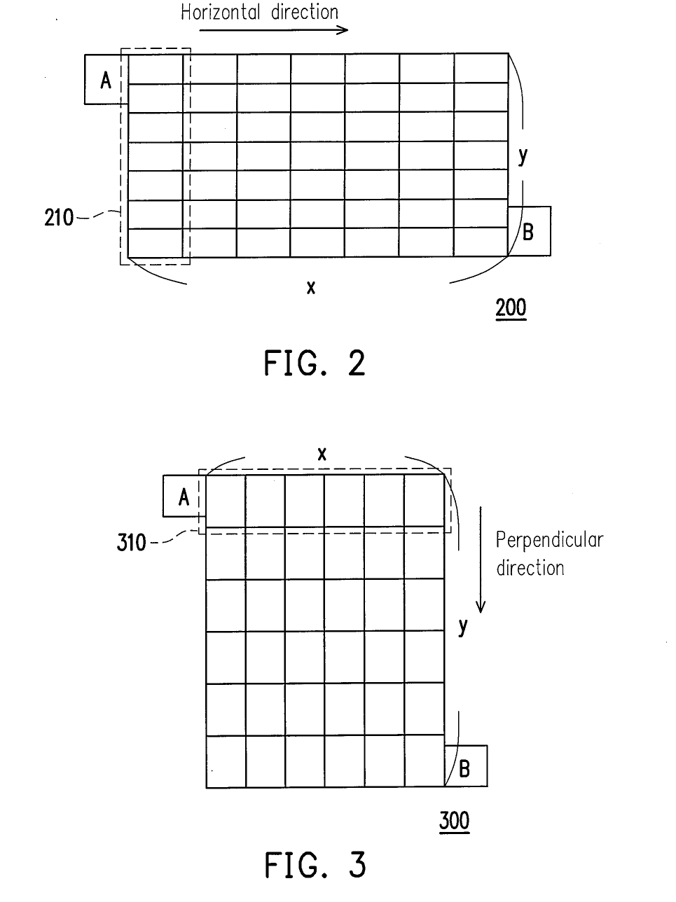

Next, in Step 120, a processing direction is determined by a relative position of the first and the second component to be routed on the circuit board. For example, in this embodiment, a rectangle with the first component and the second component as its points is first obtained, and then an aspect ratio of the rectangle is used to determine the processing direction. Further, if a horizontal distance between the first component and the second component is larger than or equal to a perpendicular distance, a horizontal direction is determined as the processing direction, and if the horizontal distance is smaller than the perpendicular distance, a perpendicular direction is determined as the processing direction. For the ease of illustration, in the following embodiments, components A and B respectively represent the first component and the second component to be routed on the circuit board. Referring to FIG. 2, in this embodiment, a circuit board 200 is divided into 49 (7×7) blocks. It is assumed that the component A needs to be connected to the component B on the circuit board 200, and as a horizontal distance x between the component A and the component B is larger than a perpendicular distance y, the processing direction is the horizontal direction. However, referring to FIG. 3, in a circuit board 300 which is divided into 30 (6×5) blocks, as the horizontal distance x between the component A and the component B is smaller than the perpendicular distance y, the processing direction is the perpendicular direction.

After the processing direction is determined in Step 130, all the blocks on the circuit board are divided into at least one set of processing blocks according to the processing direction. Taking the circuit board 200 in FIG. 2 for example, as the processing direction is the horizontal direction, the blocks in the same column of the circuit board are divided into the same set of the processing blocks (for example, a set of the processing blocks 210). That is, all the blocks on the circuit board 200 are divided into seven sets of the processing blocks. However, in the circuit board 300 of FIG. 3, as the processing direction is the perpendicular direction, the blocks in the same row of the circuit board are divided into the same set of the processing blocks (for example, a set of the processing blocks 310). After Step 130, all the blocks on the circuit board 300 are divided into six sets of the processing blocks.

Afterward, in Step 140, an analysis of the used space rate is sequentially performed on each set of the processing blocks. Taking the circuit board 200 in FIG. 2 for example, in this embodiment, as the processing direction is the horizontal direction, the analysis of the used space rate is sequentially performed on each set of the processing blocks on the circuit board 200 from the set of the processing blocks 210 nearest to the component A along the horizontal direction to the component B. However, referring to FIG. 3, if the processing direction is the perpendicular direction, and the analysis of the used space rate is sequentially performed on each set of the processing blocks on the circuit board 300 from the set of the processing blocks 310 nearest to the component A along the perpendicular direction to the component B.

Finally, in Step 150, after the analysis of the used space rate is sequentially performed on each set of the processing blocks, all blocks in each set of the processing blocks are labeled according to the analysis result so as to display all the possible routing channels between the first component and the second component (for example, the components A and B).

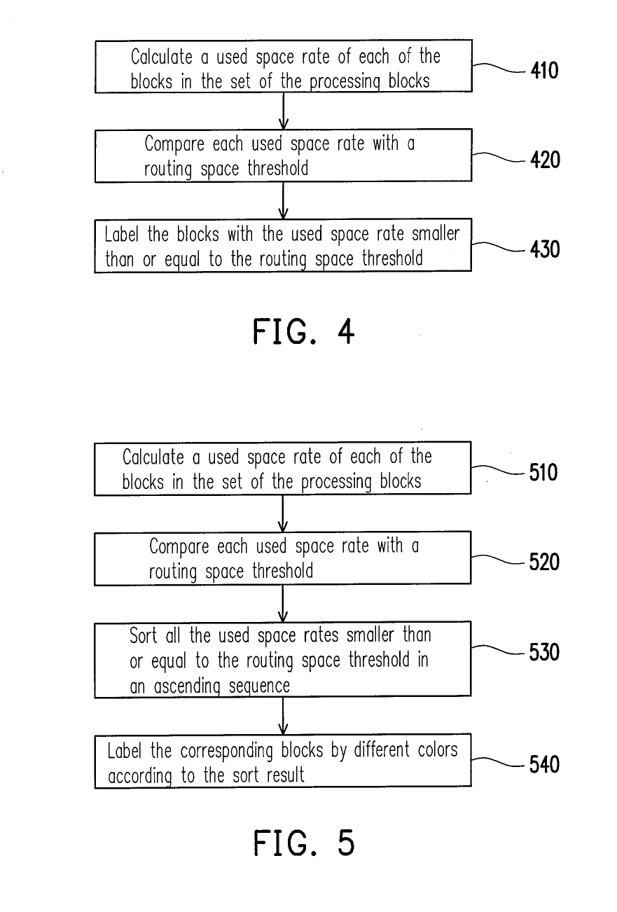

FIG. 4 is a flow chart of performing an analysis of the used space rate on each set of the processing blocks and displaying at least one routing channel based on the analysis result according to an embodiment of the present invention. Referring to FIG. 4, first, in Step 410, the used space rate of each of the blocks in each set of the processing blocks on the circuit board is calculated. In this embodiment, a ratio of a used area and a block area of each block is taken as the used space rate. The used area may be, but not limited to, a via area, a trace area, or a pin area.

Next, in Step 420, the used space rate of each block is compared with a routing space threshold. Before the comparison, the routing space threshold is calculated according to a minimum area for routing and a block area. In this embodiment, a difference between the block area and the minimum area for routing is first calculated, and a ratio of the difference and the block area is taken as the routing space threshold. If the used space rate of a block is larger than the routing space threshold, the block has no free space for routing. Therefore, as shown in Step 430, only the blocks with a used space rate smaller than or equal to the routing space threshold are labeled.

After each set of the processing blocks on the circuit board goes through the above process in FIG. 4, the blocks still having space for routing may be specially labeled in each set of the processing blocks, and those specially labeled blocks will form several channels from the first component to the second component. Therefore, the engineers may select the most suitable channel to serve as the routing channel between the first component and the second component.

Besides the aforementioned routing channel displaying method, in another embodiment, for example, the blocks with different used space rates in each set of the processing blocks are labeled by different colors, and the detailed process is shown in FIG. 5. As Steps 510 and 520 in FIG. 5 are identical or similar to Steps 410 and 420 in FIG. 4, the details will not be described herein again. Referring to Step 530, after calculating the used space rate of each block in a set of the processing blocks, all the used space rates smaller than or equal to the routing space threshold are sorted in an ascending sequence. In other words, as the block with a used space rate larger than the routing space threshold does not have free space for routing, all the used space rates larger than the routing space threshold will not be sorted. In this embodiment, for example, after being calculated, the used space rate of each block is compared with the routing space threshold, and then a bubble sort method is performed on the used space rates. However, various sort algorithms can be employed to achieve the above purpose, and the sort method is not intended to limit the present invention.

After sorting all the used space rates smaller than or equal to the routing space threshold in each set of the processing blocks, as show in Step 540, the corresponding blocks are labeled by different colors according to the sort result of the used space rates. In an embodiment, the corresponding blocks are labeled by a color of descending brightness according to the sort result, i.e., labeled by the same color with different brightness. For example, in the same set of the processing blocks, the blocks with the minimum used space rate are labeled by a color of the highest brightness (for example, the brightest green), and with the increase of the used space rates, the brightness of the color for labelling the blocks is descending accordingly (for example, the color green of descending brightness). Therefore, after the analysis of the used space rate and the labelling process shown in FIG. 5 are performed on each set of the processing blocks on the circuit board, the engineers may directly observe several curves or regions of different brightness between the first component and the second component, and the blocks corresponding to the curves or regions have enough space for routing (the curves or regions in a brighter color may provide a larger space for routing). Thereby, the engineers can easily select the most suitable channel according to requirements, and complete the routing of the circuit board.

It should be noted that, the routing channel displaying method may be performed by any computer system with a processor. In other words, the above embodiment is designed into a program and stored in a computer-accessible storage medium (for example, a memory, optical disk, or hard disk). Then, the program is loaded in a computer system to enable the computer system to execute the routing channel displaying method of the above embodiment.

In view of the above, the routing channel displaying method and the computer-accessible storage medium thereof provided by the present invention at least have the following advantages.

1. According to a relative position of the starting and the end point of the routing, all the regions available for routing on the circuit board can be gradually obtained and displayed in the corresponding processing direction, so as to make the routing of the circuit board more convenient.

2. The circuit board is divided into several blocks, and the blocks still having space for routing are obtained by grouping. Therefore, the number of the blocks to be compared each time can be reduced, thereby accelerating the comparison and determination process.

3. Under the circumstance that the circuit board still has space for routing, all the possible routing channels are displayed for selection. Therefore, unnecessary rerouting process can be effectively avoided, thus reducing the time for routing and improving the success probability and efficiency of routing.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A routing channel displaying method, applicable to a circuit board, comprising:
dividing the circuit board into m×n blocks; wherein the blocks form a matrix with size m×n, and m, n are positive integers;
determining a processing direction by a relative position of a first component and a second component of the circuit board;
dividing the blocks into at least one set of processing blocks according to the processing direction;
performing an analysis of used space rate sequentially on each set of the processing blocks; and
labelling all blocks in each set of the processing blocks according to a result of the analysis of the used space rate so as to display at least one routing channel between the first component and the second component.

2. The routing channel displaying method according to claim 1, wherein the step of determining the processing direction by the relative position of the first component and the second component of the circuit board further comprises:
determining a horizontal direction as the processing direction if a horizontal distance between the first component and the second component is larger than or equal to a perpendicular distance; and
determining a perpendicular direction as the processing direction if the horizontal distance is smaller than the perpendicular distance.

3. The routing channel displaying method according to claim 2, wherein the step of dividing the blocks into at least one set of the processing blocks according to the processing direction further comprises:
dividing the blocks in the same column of the circuit board into the same set of the processing blocks if the processing direction is the horizontal direction; and
dividing the blocks in the same row of the circuit board into the same set of the processing blocks if the processing direction is the perpendicular direction.

4. The routing channel displaying method according to claim 2, wherein the step of performing the analysis of the used space rate sequentially on each set of the processing blocks further comprises:
performing the analysis of the used space rate sequentially on each set of the processing blocks from the set of the processing blocks nearest to one of the first component and the second component along the horizontal direction to the other one of the first component and the second component if the processing direction is the horizontal direction; and
performing the analysis of the used space rate sequentially on each set of the processing blocks from the set of the processing blocks nearest to one of the first component and the second component along the perpendicular direction to the other one of the first component and the second component if the processing direction is the perpendicular direction.

5. The routing channel displaying method according to claim 1, wherein the step of performing the analysis of the used space rate sequentially on each set of the processing blocks further comprises:
calculating a used space rate of each of the blocks in the set of the processing blocks.

6. The routing channel displaying method according to claim 5, wherein the step of calculating the used space rate of each of the blocks further comprises:
taking a ratio of a used area and a block area of each block as the used space rate.

7. The routing channel displaying method according to claim 6, wherein the used area at least comprises a via area, a trace area, or a pin area.

8. The routing channel displaying method according to claim 5, after the step of calculating the used space rate of each of the blocks, further comprising:
comparing each used space rate with a routing space threshold.

9. The routing channel displaying method according to claim 8, further comprising:
calculating a difference between a block area and a minimum area for routing; and
taking a ratio of the difference and the block area as the routing space threshold.

10. The routing channel displaying method according to claim 8, wherein the step of labelling all blocks in each set of the processing blocks according to the result of the analysis of the used space rate so as to display at least one routing channel further comprises:
labelling the blocks with the used space rate smaller than or equal to the routing space threshold in each set of the processing blocks.

11. The routing channel displaying method according to claim 8, after the step of comparing each used space rate with the routing space threshold, further comprising:
sorting all the used space rates smaller than or equal to the routing space threshold in an ascending sequence in each set of the processing blocks.

12. The routing channel displaying method according to claim 11, wherein the step of labelling all blocks in each set of the processing blocks according to the result of the analysis of the used space rate so as to display at least one routing channel further comprises:
labelling the corresponding blocks by different colors according to a sort result of the used space rates in each set of the processing blocks.

13. The routing channel displaying method according to claim 12, wherein the step of labelling the corresponding blocks by different colors according to the sort result further comprises:
labelling each corresponding block by a color of descending brightness according to the sort result.

14. A computer-accessible storage medium, for storing a program, wherein the program is loaded in a computer system to enable the computer system to execute the method according to claim 1.
